(19) United States
(12) Patent Application Publication
(10) Pub. No.: US 2003/0158028 A1
(43) Pub. Date: Aug. 21, 2003

(54) Solarization resistant materials having reduced ultraviolet absorption for use in fabrication of optical elements

(76) Inventors: Dominic Loiacono, Budd Lake, NJ (US); Dan Perlov, Bogota, NJ (US)

Correspondence Address: STALLMAN & POLLOCK LLP, ATTN Michael A Stallman, 121 Spear Street, Suite 290, San Francisco, CA, 94105, US

(21) Appl. No.: 10/077,366

(22) Filed: Feb. 15, 2002

(51) Int. Cl. C03C 3/32; C04B 33/00; C04B 35/03; C04B 35/16; G02B 1/00; G02B 3/00; G02B 7/00; G02B 9/00; G02B 11/00; G02B 13/00; G02B 15/00; G02B 17/00; G02B 25/00

(52) U.S. Cl. 501/40; 501/151; 359/350; 359/642

(57) ABSTRACT

No-bridging fluorine sites in calcium fluoride (CaF₂) caused by lanthanide, transition metal or actinide impurities are eliminated by doping the CaF₂ with sodium or another monovalent anionic dopant during or after growth of the crystal. This doping technique may be applied in the growth of other UV-transmissive fluoride materials in a family designated by a general formula Z:XF_{N} where X is one or some combination of magnesium, calcium, zinc, strontium, cadmium, and barium, Z is one or some combination of lithium, sodium, potassium, rubidium, cesium, thallium, copper, silver and gold, and N is an integer in the range 1 through 6, and dependant on X. Elimination of the non-bridging fluorine sites can provide solarization resistant materials with low UV absorption even when the material contains sufficient lanthanide transition metal, or actinide impurities to cause the fluoride materials to be highly absorbing for UV radiation in the absence of the monovalent anion doping.

### TECHNICAL FIELD OF THE INVENTION

The present invention relates generally to optical materials for use in manufacturing optical elements required to transmit ultraviolet (UV) radiation. The invention relates in particular to UV transmissive fluorides doped with a monovalent metallic element for reducing UV absorption in the material.

### DISCUSSION OF BACKGROUND ART

Ultraviolet lasers are extensively used in the electronics industry to provide ultraviolet radiation for operations such as UV drilling and machining of printed circuit boards, and photoresist exposure in photolithographic operations for microchip manufacture. Ultraviolet radiation is generally regarded as radiation having a wavelength less than about 425 nanometers (nm). Lasers commonly used in photolithographic operations included frequency-doubled argon ion lasers which can provide tens of watts of UV radiation at a wavelength of 244 nm, and excimer lasers which can provide similarly powerful UV radiation at wavelengths of 157 nm and 197 nm, among other wavelengths.

In UV laser photolithographic operations, laser radiation is not used directly from the laser but is projected by an optical system including one or more optical elements such as a lens, a window, or the like. These optics must have the lowest possible absorption for the particular laser wavelength projected by the optical system. Generally preferred materials for manufacturing such optical elements are UV-grade fused silica (SiO₂) and calcium fluoride (CaF₂). CaF₂ is preferred for wavelengths of 244 nm or less. Manufacturers of CaF₂ continue to try to reduce UV absorption in the material by reducing impurity content of the material. However, the best commercially available CaF₂ material still has a significant degree of absorption, for example, about 0.5% per centimeter. This absorption is sufficiently high that an optical element made from the material will eventually degrade as a result of damage caused by absorbed UV radiation. This degradation typically takes the place of a progressively increasing absorption generally referred to in the optical industry as solarization. The solarization damage in an optical element results in progressively lower light throughput and poor overall lifetime performance. By way of example, laser machining and hole drilling require peak radiation fluence levels of 20-100 megawatts per square centimeter (MW/cm²). Optics made with the best available CaF₂ show UV radiation throughput degradation of 2% per hour under these fluence levels.

In order to reduce the impact of solarization of UV-transmitting optical elements there is a need for UV-transmissive material wherein UV absorption is reduced significantly below the lowest levels achieved in prior-art commercially available materials. In the case of CaF₂ and similar UV transmissive fluoride materials, absorption of ultraviolet radiation occurs because of non-bridging fluorine (F) atoms located in the crystal lattice. The non-bridging fluorine atoms (or interstitial fluorine) are located in the crystalline material due to defects and impurities present in the material. It is believed that the elimination of the non-bridging fluorine atoms in such UV transmissive fluoride materials, without necessarily eliminating the impurities that give rise to these non-bridging fluorine atoms, can result in a material in which absorption of ultraviolet radiation at UV laser wavelengths will be significantly reduced relative to prior art materials, if not entirely eliminated. Such materials should exhibit a corresponding significant increase in resistance to solarization damage.

### SUMMARY OF THE INVENTION

In an approach in accordance with the present invention to minimizing absorption in UV transmissive fluoride material, non-bridging fluorine atoms are reduced or eliminated by incorporating in the material a negative monovalent dopant. By way of example, in the case of CaF₂, calcium (Ca) has a valence of +2. The predominant impurities in calcium fluoride are the Lanthanide elements and transition metals, which have valence of +3. These materials substitute for Ca in the crystal lattice of the material and lead to a positive charge imbalance (+1). A charge compensation mechanism naturally occurs in the CaF₂ by creating the non-bridging fluorine (F⁻¹) sites. By doping the impurity-containing CaF₂ with sufficient quantity of an element that will exchange for calcium and has a valence of +1, there is no longer a charge imbalance, and no non-bridging fluorine (F⁻¹) sites are created. Accordingly, UV absorption is reduced and the solarization susceptibility of the material is minimized, if not eliminated completely.

In a general aspect, a UV-transmissive fluoride material in accordance with the present invention consists essentially of a material defined by a general formula Z:XF_{N}, where X defines at least one metal selected from the group of metals consisting of magnesium (Mg), calcium (Ca), zinc (Zn), strontium (Sr), cadmium (Cd), and barium (Ba). N is 2, 4, or 6 and depends on whether respectively one, two or three metals are selected for X. XF_{N} may be defined as a host material, and Z may be defined as a dopant material. Z defines at least one metal selected from the group of metals consisting of lithium (Li), sodium (Na), potassium (K), rubidium (Rb), cesium (Cs), thallium (Tl), copper (Cu), silver (Ag) and gold (Au).

The terminology “consists essentially” as used in this description and in the claims appended hereto means that the material includes a finite proportion of impurities up to about 2% by weight. These impurities include at least one lanthanide selected from the group of lanthanides consisting of lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), lutetium (Lu), or at least one metal selected from the group of metals consisting of titanium (Ti), vanadium (V), chromium (Cr), manganese (Mn), iron (Fe), uranium (U). In this group, Ti, V, Cr, Mn, Fe, are transition metals, while uranium is an actinide. Preferably the dopant material is present in at least the same mole proportion and preferably greater than the total mole proportion of any lanthanide and transition metal impurities.

In one experiment to demonstrate the effectiveness of the doping method of the present invention, a doped CaF₂ material in accordance with the present invention was grown as a crystal by a standard Bridgeman technique. In a starting charge for the Bridgeman furnace, a CaF₂ host material was intentionally contaminated by the addition of 0.1 mol % of cerium as an impurity. Sodium (Na⁺¹) in the form of sodium fluoride (NaF) was added to the starting charge in the amount of 2 mole % to compensate for the presence of the cerium impurity.

An optical element was fabricated from the as-grown crystal. In accordance with the above-discussed general formula, the crystal consists essentially of Na: CaF₂. The optical element has an optical thickness of 12 mm. 40 W/cm² of CW laser radiation having a wavelength of 244 nm was passed through the optical element. Initial absorption of the element was comparable with the theoretical absorption of pure CaF₂. It is pointed out here that if a 12 mm-thick CaF₂ element contained 0.1 mol % of cerium as an impurity, and did not contain any Na to compensate for this level of impurity, it would be essentially completely opaque at 244 nm. The experimental, Na-doped optical element showed no evidence of solarization over 2 hours of irradiation with the 40 W/cm² of continuous wave (CW) 244 nm laser radiation. At this fluence level a prior art commercially available CaF₂ element would exhibit throughput reduction of about 2% per hour.

In a particular aspect of the present invention the action of above discussed impurities on the CaF₂ material can be regarded as (unwanted) doping of the material. The unwanted doping, here, creating the non-bridging fluorine sites that the inventive (intentional) doping seeks to eliminate. According to this aspect of the present invention we can define the inventive CaF₂ material by a formula QZ:XF_{N}, where X and N are as defined above and Q is an impurity or impurities, for example, an impurity or impurities from the groups of impurities defined above.

### DETAILED DESCRIPTION OF THE INVENTION

As summarized above, the present invention is directed to an inventive family of UV transmissive materials having a general formula:

Z:XF_{N} (1)

Wherein, X defines a metal or combination of metals selected from the group consisting of Mg, Ca, Zn, Sr, Cd, and Ba, and N is 2, 4, or 6, and depending on whether respectively one, two, or three metals are selected for X. XF_{N} has a cubic crystal structure and may be defined as a host material, and Z may be defined as a dopant material. Z defines at least one metal selected from the group consisting of Li, Na, K, Rb, Cs, Tl, Cu, Ag, and Au.

The intent of the doping is to reduce or eliminate bridging F⁻¹ sites in the crystal lattice of the material. These sites are believed to be caused by impurities, in particular one or more lanthanides from the group consisting of La, Ce, Pr, Nd, Pm, Sm, Eu, Gd, Tb, Dy, Ho, Er, Tm, Yb, and Lu, or, not exclusively, one or more transition metals from a group of transition metals and an actinide consisting of Ti, V, Cr, Mn, Fe, and U, where U is the actinide. It is believed that the non-bridging F⁻¹ sites compensate for a positive charge imbalance that would be created by the impurity or impurities in the absence of such sites. Depending on the method selected for growing the material, the dopant can be added directly, as a metal, or indirectly, for example, as a fluoride of the dopant metal to the fluoride host material during the production of the inventive material. Preferably, the dopant material is present in at least the same or greater mole proportion than the total mole proportion of any lanthanide and transition metal impurities.

It should be noted that if the added dopant percentage exceeds the impurity percentage, there is no significant adverse effect of the excess dopant. If dopant is added in too high a percentage, the crystal will simply reject excess material. It is important, however, that the proportion of dopant does not approach 100 mole %. A mole proportion of dopant Z could result in the growth of a compound fluoride of the form ZXF₃ in which case Z would no longer be a dopant. Further compound fluorides of the form ZXF₃ have a perovskite crystal structure instead of the cubic crystal structure of the inventive fluorides. A crystal having a perovskite structure has a disadvantage that it is strongly birefringent. This birefringence can restrict the usefulness of the crystal for forming optical elements for use in well-corrected optical systems. It is recommended that in no case should the mole proportion of Z in the inventive fluorides exceed 50%. A mole proportion of Z less than 10% will usually be found adequate to achieve the effect of minimizing or eliminating non-bridging fluorine sites.

As discussed above, CaF₂ is a commonly used material for ultraviolet-radiation-transmitting optical elements. The ultraviolet radiation transmission properties of the material are well documented in the prior art. Accordingly, this material was selected to evaluate the inventive monovalent-anion doping approach to eliminating non-bridging fluorine sites and the absorption of ultraviolet radiation caused by these sites. CaF₂ material not specifically refined for high fluence UV transmission may contain up to about 2% impurities, i.e., may have a purity of about 98% or greater. High purity material, preferable for high fluence UV transmission applications, is typically about 99.99% pure.

In one experiment, a monovalent anion doped CaF₂ crystal was grown by a standard Bridgeman method. A CaF₂ charge for the Bridgeman furnace was intentionally contaminated by the addition of 0.1 mole percent of Cerium. CaF₂ powder (or broken crystals) in the amount of 12.8074 moles were mixed with cerium fluoride (CeF₃) powder to deliberately introduce Ce as an impurity. Sodium (Na⁺¹) in the form of sodium fluoride (NaF) was added to the starting charge in the amount of 2 mole percent to compensate for the presence of cerium. In order to remove any unwanted oxides from the starting materials, 0.01 to 5.0 mole percent of lead fluoride (PbF₂) was added to the mixture. The mixture was blended in a plastic bottle to ensure homogeneity and loaded into a 90 millimeter (mm)×150 mm graphite crucible.

This crucible was shaped at one end with a 45° Bridgeman taper. The crucible was sealed with a graphite lid. The loaded crucible was placed into a 2-zone, vacuum high-temperature furnace. The furnace was sequentially evacuated and back filled with argon gas three times in order to remove any water or oxygen. A temperature sequence for the furnace to grow the crystal was as follows: 0.5 Hrs. to 400° C.; 0.5 Hr. dwell time at 400° C.; 0.5 Hrs. to 1450° C., to melt the mixture; and dwell at 1450° C. for the remainder of the growth.

After the temperature has reached 1450° C. and dwelled at that temperature for 1 Hr., the crucible was lowered out of the heated zone of the furnace at a rate between 0.5-2.0 mm per hour. After 150 mm of travel, the growth procedure was complete and the furnace was cooled in 24 hrs to room temperature. The crystal was removed from the furnace.

An optical element was fabricated from the as-grown crystal. The optical element has an optical thickness of 12 mm. 40 (Watts per square centimeter (W/cm²) of CW laser irradiation having a wavelength of 244 nm was passed through the optical element. The UV radiation transmission through optical element has been monitored as a function of exposure time by a UV-light detector. Initial absorption of the element was comparable with theoretical absorption of pure CaF₂. As noted above, if such a cerium-doped CaF₂ element had been made without compensation with sodium, it would be completely opaque at 244 nm, i.e., no 244 nm radiation would reach the detector. The experimental, Na-doped optical element showed no evidence of solarization over 2 hours of irradiation with the 40 W/cm² of CW 244 nm laser radiation.

It should be noted here that the above-described Bridgeman method is not the only method by which the inventive doped fluoride materials may be grown. Some alternative growth methods are discussed briefly hereinbelow. These methods are discussed with reference to growing sodium-doped calcium fluoride (Na:CaF₂) but may be applied to the growth of other materials in the inventive family of UV-transmissive doped fluorides.

In one alternative crystal growth method a generally referred to as a “gradient freeze method” a CaF₂ mixture in a graphite crucible as discussed above with reference to the standard Bridgeman method of growth are placed in a vacuum furnace and the furnace is sequentially evacuated and back filled with argon gas three times to remove any water or oxygen. The temperature in the furnace is raised to 1450° C. to melt the mixture and held at that temperature for 2 hours. A temperature gradient of 1 to 20° C. per centimeter is created along the vertical axis of the crucible. The furnace is then slowly cooled at 5-20° C. per hour to grow the crystal. When the temperature reaches 1250° C. the furnace is cooled to room temperature at 50° C. per hour. The crystal is removed from the furnace and may be used for the fabrication of one or more optical elements.

In another crystal growth method, a CaF₂ mixture as discussed above with reference to the standard Bridgeman method of growth is placed into a 90 mm diameter, flat bottom, graphite crucible and placed in the vacuum furnace. The furnace is sequentially evacuated and back filled with argon gas three times prior to the heating cycle. The furnace temperature is then raised to 1450° C. to melt the mixture and homogenized for two hours. Typical Czochralski growth technique (or flux-growth technique) is used, starting with the introduction of a seed crystal at the top of the melt.

The seed crystal is rotated at 2-20 revolutions per minute (rpm) and the temperature lowered until the onset of nucleation on the seed crystal. After nucleation on the seed crystal, the crystal can be grown by pulling the growing crystal out of the top of the melt at rates of 0.1-5.0 mm per hour. When a sufficient length of the crystal is achieved, the crystal is detached from the remaining melt and the furnace is cooled to room temperature in 24 hours.

In yet another method for growing the inventive Na-doped CaF₂ material, a crystalline layer of the material is epitaxially grown. A suitable single crystal substrate, preferably a CaF₂ substrate, is placed in a high vacuum deposition chamber. The substrate is heated to 400 to 600° C. prior to film growth. CaF₂ and sodium fluoride NaF are co-deposited on the substrate in appropriate proportions, by thermal evaporation or sputtering techniques, to grow an epitaxial layer of Na:CaF₂ on the substrate. Following growth of the layer, the substrate is separated from the layer by grinding, polishing, etching or the like.

In still another alternative method for forming the inventive Na:CaF₂ material, a diffusion process is used to introduce Na⁺¹ ions into an undoped CaF₂ crystal previously grown, for example, by the Bridgeman or Czochralski method. Such a crystal is placed in a vacuum furnace, which is sequentially evacuated and back filled with argon gas three times in order to remove any water or oxygen. The furnace temperature is raised to 800 to 1395° C. (below the melting point of the crystal) and sodium-containing gas (or vapor) is introduced into the furnace. The introduction of the gas above the crystal causes in-diffusion into the crystal of a small percentage of the sodium contained in the gas. After about two hours of sodium in-diffusion, the crystal, now a Na:CaF₂ crystal, is cooled to room temperature and removed from the furnace.

While all of the above-described growth methods are discussed, for comparison purposes, with respect to growth of Na:CaF₂, one or more of the methods may be suitable for growth of other of the inventive UV-transmissive fluoride materials. By way of example, it is believed that lithium-doped magnesium fluoride (Li:MgF₂), potassium-doped barium fluoride (K:BaF₂), and lithium-doped magnesium barium fluoride (Li:MgBaF₄) may be grown by a standard Bridgeman method. These are three materials that it is believed may also provide commercially cost effective, less UV-absorptive, solarization resistant alternatives to the prior-art CaF₂ material commonly used for making UV-transmissive optical elements.

Regarding growth methods, certain above described crystal growth methods provide the inventive fluoride material in the form of a boule, the boule being in the form of a single crystal, or two three large “grains” of single crystal that may be treated essentially as a single crystal. The boule, or sections from the boule, may be used to provide one or more of what are generally referred to in the optical art as “blanks” for forming an optical element. It is also possible to form such a blank from the inventive material in relatively fine-grained, powder-like, polycrystalline form. This may be done by pressing the powder in a mold to form the blank. Hot isostatic pressing is one preferred pressing method. The powder or granular form of the material may be obtained, for example, by breaking a boule of the material grown by one of the above-described methods and grinding fragments of the boule.

The present invention is described above in terms of a preferred and other embodiments. The invention, however, is not limited to the embodiments described herein. Rather, the invention is limited only by the claims appended hereto.

What is claimed is:

1. An optical element, the invention characterized in that:
the optical element is formed from a material consisting essentially of a fluoride having a general formula Z:XF_{N}, where X is at least one metal selected from the group of metals consisting of Mg, Ca, Zn, Sr, Cd, and Ba, N is one of 2, 4, and 6, and corresponds to the number of metals selected for X, and Z is at least one dopant selected from the group consisting of Li, Na, K, Rb, Cs, Ti, Cu, Ag and Au.

2. The optical element of claim 1, wherein the material is in polycrystalline form.

3. The optical element of claim 2, wherein the material is in single crystal form.

4. The optical element of claim 1, wherein said material includes one or impurities including at least one metal in the group consisting of La, Ce, Pr, Nd, Pm, Sm, Eu, Gd, Tb, Dy, Ho, Er, Tm, Yb, Lu, Ti, V, Cr, Mn, Fe, and U.

5. The optical element of claim 4, wherein the mole percentage of Z in the material is equal to or greater than the total mole percentage of said one or more impurities.

6. The optical element of claim 5, wherein the weight percentage of impurities is about 2% or less.

7. The optical element of claim 1, wherein X is Ca, Z is Na and N is 2.

8. The optical element of claim 1, wherein X is Mg, Z is Li and N is 2.

9. The optical element of claim 1, wherein X is Ba, Z is K and N is 2.

10. The optical element of claim 1, wherein X is B and Mg, Z is Li and N is 4.

11. An ultraviolet transmitting material defined by the formula:
QZ:XF_{N}
wherein, X is a metal or a combination of metals selected from the group consisting of Mg, Ca, Zn, Sr, Cd, and Ba;
N is one of 2, 4, and 6, and corresponds to the metal or combination of metals selected for X;
Q is at least one impurity, including at least one metal in the group consisting of La, Ce, Pr, Nd, Pm, Sm, Eu, Gd, Tb, Dy, Ho, Er, Tm, Yb, Lu, Ti, V, Cr, Mn, Fe, and U; and
Z is a dopant including at least one metal selected from the group consisting of Li, Na, K, Rb, Cs, Tl, Cu, Ag and Au.

12. The material of claim 9, wherein the mole percentage of Z in the material is greater than the mole percentage of Q in the material.

13. The material of claim 11, wherein Q is present in the material in a weight percentage of about 2% or less.

14. An optical element, the invention characterized in that:
the optical element is formed from sodium-doped calcium fluoride.

15. The optical element of claim 14, wherein the sodium-doped calcium fluoride includes up to 2% of at least one or more impurities including at least one metal in the group consisting of La, Ce, Pr, Nd, Pm, Sm, Eu, Gd, Tb, Dy, Ho, Er, Tm, Yb, Lu, Ti, V, Cr, Mn, Fe, and U.
